(19) United States
(12) Patent Application Publication
(10) Pub. No.: US 2016/0053075 A1
(43) Pub. Date: Feb. 25, 2016

(54) EXTRUDABLE CAPSTOCK COMPOSITIONS

(71) Applicant: SACO POLYMERS, INC., Sheboygan, WI (US)

(72) Inventor: Jeffrey Jacob Cernohous, Hudson, WI (US)

(73) Assignee: SACO POLYMERS, INC., Sheboygan, WI (US)

(21) Appl. No.: 14/749,297

(22) Filed: Jun. 24, 2015

Related U.S. Application Data
(60) Provisional application No. 62/041,528, filed on Aug. 25, 2014.

(51) Int. Cl. C08K 3/26; C08L 1/02; C08L 51/06; C08L 97/02; B29C 47/88; B32B 27/32; B32B 27/28; B32B 27/20; B29C 47/06; C08K 3/36; B32B 27/08

(52) U.S. Cl. CPC C08K 3/26; C08K 3/36; C08L 1/02; C08L 51/06; C08L 97/02; B32B 27/08; B32B 27/32; B32B 27/283; B32B 27/20; B29C 47/065; B29C 47/8895; B29C 47/8815; C08K 2003/265; C08L 2207/066; B32B 2250/02; B32B 2250/242; B32B 2419/00; B32B 2419/06; B29K 2023/0625

(57) ABSTRACT

Compositions and methods for producing polymeric composites containing extrudable capstock compositions. The capstock composition includes crosslinkable polymer. The capstock composition can also include additives to impart certain functionality, including ultraviolet stability, ultraviolet reflectance, gloss reduction, color and microbial resistance.

### CROSS-REFERENCE TO RELATED APPLICATIONS

This patent application claims the benefit of U.S. Provisional Patent Application 62/041,528, filed on Aug. 25, 2014; the entire contents of which are hereby incorporated by reference, for any and all purposes.

### BACKGROUND

Wood plastic composites have found application in a multitude of commercial products in recent years. In 2007, the overall market for WPCs was estimated to be billions of pounds annually. By and large, the leading uses for WPC are found in construction and automotive markets. When compared to conventional mineral or glass filled composites, WPCs have lower specific gravity, better strength/weight ratio and are often lower cost. They also have the look of natural wood, while being much easier to maintain. However, WPCs have had issues with exposure to ultraviolet radiation, mold and mildew growth over the past decade.

As a result, many leading companies have commercialized decking products that have a thin, coextruded capstock layer. This layer often contains additives to impart improved ultraviolet stability and microbial resistance. Currently, the state of the art in WPC capstocks is to utilize polyolefin ionomers that contain various colorants, ultraviolet stabilizers and antimicrobial additives. These materials have greatly improved the color fastness and microbial performance of the resulting WPC article. However, these ionomers capstocks may exhibit poor adhesion creating delamination concerns. Additionally, different or mismatched coefficient of thermal expansion values of the capstock compared to the WPC core substrate that may result in cracking, warping or delamination of the capstock. The noted detrimental properties certainly limit the ultimate utility of capstocks with the WPC applications.

### SUMMARY

The present application relates to an extrudable capstock composition. The extrudable capstock composition may be an extrudable, crosslinkable capstock composition particularly useful for wood plastic composites (WPCs).

disclosure is directed to the utilization of a crosslinkable polymer capstock compositions for WPC products. The crosslinkable polymer capstock compositions have excellent adhesion to WPC core substrates. In certain embodiments, the crosslinkable polymer capstock compositions also can be designed to more closely match the coefficient of thermal expansion of the WPC core substrate. As a result, the propensity for the capstocks to delaminate in use is greatly reduced.

The capstocks of this disclosure possess outstanding durability and scratch and mar resistance. These properties are highly desirable for certain end use applications, such as composite decking products. In one embodiment, the capstock composition includes a crosslinkable polyolefin polymer. In a another embodiment, the capstock composition comprises a crosslinkable polyolefin polymer and a mineral filler. The capstock composition may also include additives to impart certain functionality, including for example, ultraviolet stability, ultraviolet reflectance, gloss reduction, color and microbial resistance.

The crosslinkable polymer composition embodied in the present application can be derived from any extrudable polymer that is amenable to a post crosslinking reaction. In one embodiment, the post crosslinking reaction is activated by exposure to moisture. In another embodiment, the post crosslinking reaction is activated by exposure to actinic radiation, for example, ultraviolet or electron beam radiation. The present capstock compositions are melt processable and may be either subsequently or concurrently melt processable.

For purposes of the present application, the following terms used in this application are defined as follows:

“Crosslinkable Polymer” means a melt processable polymeric material or composite that can be crosslinked upon exposure to moisture, heat or actinic radiation either after or concurrently with melt processing.

“Composite” means a mixture of a polymeric material and an additive or filler.

“Melt Processable Composition” means a formulation that is melt processed, typically at elevated temperatures, by means of a conventional polymer processing technique such as extrusion or injection molding as an example.

“Melt Processing Techniques” means extrusion, injection molding, blow molding, rotomolding, or batch mixing.

“Wood Plastic Composite or WPC ” means a composite material that comprises polymeric matrix and at least one cellulosic filler.

The above summary of the present method and compositions is not intended to describe each disclosed embodiment or every implementation of an embodiment. The detailed description that follows more particularly exemplifies illustrative embodiments.

### DETAILED DESCRIPTION

Articles and various embodiments under this disclosure include a polymeric capstock generally produced by coextruding crosslinkable polymers onto a wood plastic composite substrate using conventional melt processing techniques.

The crosslinkable polymers suitable for formation of a capstock may include polymers generally recognized by those of ordinary skill in the art as being capable of crosslinking upon exposure to moisture, thermal energy or actinic radiation. Non-limiting examples of crosslinkable polymers suitable for practicing the present method includes polyolefins, such as for example, silane grafted polyolefins.

In one aspect, the crosslinkable polymer is a crosslinkable polyolefin. Non-limiting examples of crosslinkable polyolefins include silane grafted polyethylene, silane grafted polyethylene copolymers (e.g., ethylene/hexene, ethylene/octene, or other ethylene copolymer comprising a C3-C8 alpha-olefin, ethylene/vinyl acetate, ethylene/acrylate, ethylene/propylene) and silane grafted polypropylene. Preferable silanes moieties grafted to the polymer backbone include trimethoxy and triethoxy silane.

Crosslinkable polymers for use in the present method and compositions can be produced in any manner known in the art, including reactive extrusion. In reactive extrusion, the base polymer is reacted with a ethylenically unsaturated crosslinkable monomer in the presence of a free radical initiator. In one embodiment, ethylenically unsaturated alkoxy silane monomers can be reacted with a base polymer in the presence of a free radical initiator. In a preferred embodiment, vinyl trialkoxy silanes are preferred crosslinkable monomers.

A free radical initiator may be employed to create a crosslinkable polymer. Preferred free radical initiators are any of those known in the art including diazo compounds and peroxy compounds. Those skilled in the art with knowledge of this disclosure recognize that the appropriate selection of a free radical initiator is determined by the melt processing conditions (e.g., temperature and residence time) required to facilitate effective grafting of the crosslinkable monomer to the polymer backbone.

The amount of crosslinkable monomer in the crosslinkable polymer composition can vary. In one embodiment, the crosslinkable monomer comprises 0.05 to 20 wt % of the crosslinkable polymer composition. In some embodiments, the crosslinkable monomer comprises 0.1 to 10 wt % of the crosslinkable polymer composition and yet in other embodiments, the crosslinkable monomer comprises 0.25 to 5 wt % of the crosslinkable polymer composition. In a preferred embodiment, the crosslinkable monomer is an alkoxysilane as described in U.S. Pat. No. 4,397,981, U.S. Pat. No. 4,413,066, U.S. Pat. No. 4,462,83, U.S. Pat. No. 4,857,259 and U.S. Pat. No. 5,260,381, which are herein incorporated by reference.

The amount of crosslinkable polymer in the capstock composition can vary. In one embodiment, the capstock composition comprises 1 to 100 wt % of the crosslinkable polymer. In another embodiment, the capstock composition comprises 5 to 95 wt % of the crosslinkable polymer. In yet another embodiment, the capstock composition comprises 10 to 75 wt % of the crosslinkable polymer.

In another aspect, the melt processable capstock composition may contain other additives. Non-limiting examples of conventional additives include antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet reflective additives, infrared reflective additives, thermally conductive additives and/or pigments. The additives may be incorporated into the melt processable capstock composition in the form of powders, pellets, granules, or in any other extrudable form. The amount and type of conventional additives in the melt processable composition may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

The melt processable capstock composition may also contain fillers. Fillers can function to improve mechanical and thermal properties of the capstock. Fillers can also be utilized to reduce coefficient of thermal expansion (CTE) of the capstock composition, in order to minimize the difference in CTE between the capstock and the intended WPC core. Non-limiting examples of fillers include mineral and organic fillers (e.g., talc, mica, clay, silica, alumina, carbon fiber, carbon black glass fiber) and conventional cellulosic materials (e.g., wood flour, wood fibers, sawdust, wood shavings, newsprint, paper, flax, hemp, wheat straw, rice hulls, kenaf, jute, sisal, peanut shells, soy hulls, and/or other cellulose containing material). The amount of filler in the melt processable composition may vary depending upon the polymeric matrix and the desired physical properties of the finished composition. In certain embodiments, fillers may include calcium carbonate, talc, clay and cellulosic fiber. In one embodiment, the filler comprises 1-90 wt % of the capstock formulation. Alternatively, the filler comprises 5-75 wt % of the capstock formulations or even 10-60 wt % of the capstock formulation.

The melt processable, crosslinkable capstock composition can be prepared by any of a variety of ways. For example, the polymer and optional filler and additives can be combined together by any of the blending means usually employed in the plastics industry, such as with a compounding mill, a Banbury mixer, or a mixing extruder. The materials may be used in the form, for example, of a powder, a pellet, or a granular product. The mixing operation is most conveniently carried out at a temperature above the melting point or softening point of the polymer. The resulting melt-blended mixture can be either extruded directly into the form of the final product shape or pelletized or otherwise comminuted into a desired particulate size or size distribution and fed to an extruder, which typically will be a twin-screw extruder, that melt-processes the blended mixture to form the final product shape. Alternatively, the composition may produced by dry blending a masterbatch of the additives and filler with the crosslinkable polymer and directly extruding this composition onto the WPC core. The resulting capstock exhibits superior performance (i.e., adhesion to core, scratch and mar resistance, UV resistance) when produced using this protocol.

The wood plastic composite core is typically comprised of a polymeric matrix and a cellulosic filler. In one embodiment the filler is a cellulosic material, such as for example, wood flour. In a one exemplary embodiment, the filler comprises 5-70 wt % of the composition, 15-65 wt %, or 25-60 wt %.

The polymeric matrix of the wood plastic composite core functions as the host polymer and is a primary component of the melt processable composition. A wide variety of polymers conventionally recognized in the art as suitable for melt processing are useful as the polymeric matrix. They include both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates and/or polymethylacrylates.

The polymeric matrix may include blended polymers. Non-limiting examples of polymers for blending include, high density polyethylene (HDPE), low density polyethylene (LDPE), linear low density polyethylene (LLDPE), polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyacetals, polycarbonates, polyphenylene oxides, polyurethanes, thermoplastic elastomers (e.g., SIS, SEBS, SBS), epoxies, alkyds, melamines, phenolics, ureas, vinyl esters or combinations thereof. An exemplary blend suitable for polymeric matrices are polyolefins and thermoplastic elastomers.

In another aspect, the melt processable wood plastic composite core of the present composition may include additional fillers. Typically, when a polymer matrix is melt processed with increasing loading levels of a filler, the flexural modulus of the resulting composite typically increases, but the impact strength decreases. By adding the reinforcing additives employed in the present compositions to a filled polymeric matrix, the flexural modulus and impact strength both increase. Non-limiting examples of fillers include mineral and organic fillers (e.g., talc, mica, clay, silica, alumina, carbon fiber, carbon black glass fiber) and conventional cellulosic materials (e.g., wood flour, wood fibers, sawdust, wood shavings, newsprint, paper, flax, hemp, wheat straw, rice hulls, kenaf, jute, sisal, peanut shells, soy hulls, or any cellulose containing material). The amount of filler in the melt processable wood plastic composite core composition may vary depending upon the polymeric matrix and the desired physical properties of the finished composition. Those skilled in the art of melt processing polymers are capable of selecting appropriate amounts and types of fillers to match a specific polymeric matrix.

The amount of the filler in the melt processable wood plastic composite core composition may vary depending upon the polymeric matrix and the desired physical properties of the finished composition. In view of the present disclosure, the selection of an appropriate amount and type of filler(s) can be made to match with a specific polymeric matrix in order to achieve desired physical properties of the finished material. Typically, the filler may be incorporated into the melt processable composition in amounts up to about 90% by weight. The filler is generally added to the melt processable composite composition at levels between 5 and 90%, between 15 and 80%, or between 25 and 70% by weight of the formulation. Additionally, the filler may be provided in various forms depending on the specific polymeric matrices and end use applications. Non-limiting examples of filler form include, powder and pellets.

In another aspect, the melt processable wood plastic composite core composition may contain other additives. Non-limiting examples of conventional additives include antioxidants, light stabilizers, fibers, blowing agents, foaming additives, antiblocking agents, heat stabilizers, impact modifiers, biocides, compatibilizers, flame retardants, plasticizers, tackifiers, colorants, processing aids, lubricants, coupling agents, and/or pigments. The additives may be incorporated into the melt processable composition in the form of powders, pellets, granules, or in any other extrudable form. The amount and type of conventional additives in the melt processable composition may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

Melt-processing of the wood plastic composite core and capstock are typically performed at a temperature from 80° to 300° C., although optimum operating temperatures are selected depending upon the melting point, melt viscosity, and thermal stability of the composition. Different types of melt processing equipment, such as extruders, may be used to process the present melt processable compositions.

Crosslinking of the extrudable, crosslinkable capstock composition can be performed by exposure to moisture, thermal energy or actinic radiation depending on the specific capstock chemistry being utilized. In one embodiment, a silane grafted polymer is extruded onto a WPC core and post crosslinked by exposure to moisture just after the co-extrusion die. For example, the co-extruded substrate may be cooled in a water bath and while simultaneously initiating the crosslinking process. This crosslinking reaction can be optionally accelerated by including a catalyst in the capstock formulation. Catalysts useful for improving the kinetics of moisture cure crosslinking processes can be any of those known in the art.

The present composites are suitable for manufacturing articles in the building and construction industries. For example, articles incorporating the present composition may include: building components such as decking, siding, roofing and fencing.

The resulting articles produced by melt processing the present composition exhibit superior characteristics. For example, wood plastic composites extruded with the capstocks described in this application can have improved scratch and mar resistance, adhesion characteristics, microbial resistance, color fastness and/or flame retardant characteristics.

### EXAMPLE

Materials utilized to produce illustrative examples of the present compositions are listed in Table 1.

TABLE 1

| Material | Description |
|---|---|
| Crosslinkable Polymer | Pexidan A1001, silane grafted polyethylene, |
| | commercially available from Saco Polymers |
| | Inc. (Sheboygan, WI) |
| LLDPE | Sclair 31E, linear low density polyethylene, |
| | commercially available from Nova Chemical |
| | (Calgary, AB) |
| Filler | Calcium Carbonate, GLC-1012, |
| | commercially available from Great Lakes |
| | Calcium (Green Bay, WI) |

A 50/50 masterbatch of LLDPE and filler was produced by dry blending filler and LLDPE in a polyethylene bag. The resulting blend was volumetrically fed into the feed zone of a 27 mm co-rotating twin screw extruder fitted with three strand die (commercial available from American Leistritz Extruder Corporation, Sommerville, N.J.). All samples were processed at 150 rpm screw speed using the following temperature profile: Zone 1−2=170° C., Zone 3−4=180° C., Zone 5−6=190° C., Zone 7−8=190° C. The resulting strands were subsequently cooled in a water bath and pelletized into ˜¼″ pellets. The pellets were subsequently dry blended in a 1:1 ratio with the crosslinkable polymer. The blend was fed into a single screw capstock extruder in a composite decking co-extrusion line (commercially available from Cincinnati Milacron). The resulting profile was extruded into a cooling spray tank and subsequently cut to length. The resulting capstock material had outstanding adhesion to the inner composite layer.

What is claimed is:

1. A composite composition comprising:
(a) a substrate comprising a melt processable polymeric composite, wherein the substrate has at least one surface suitable for bonding to another polymer; and
(b) capstock, which comprises a crosslinkable polymer , bonded to the at least one surface of the substrate , wherein the crosslinkable polymer is a silane grafted polyolefin; and
wherein the melt processable polymeric composite comprises polyolefin and a first filler, which includes cellulosic material and/or silica.

2. A composition according to claim 1, wherein the capstock comprises a polymer blend which includes polyethylene and silane grafted polyethylene; and the polymeric composite comprises polyethylene and/or polypropylene.

3. The composition of claim 2, wherein the silane grafted polyethylene is an alkoxysilane grafted polyethylene.

4. The composition of claim 2, wherein the capstock further comprises a second filler.

5. The composition of claim 2, wherein the capstock further comprises one or more additives selected from the group consisting of antioxidants, light stabilizers, fibers, blowing agents, foaming additives, antiblocking agents, heat stabilizers, impact modifiers, biocides, antimicrobial additives, compatibilizers, plasticizers, tackifiers, colorants, processing aids, lubricants, coupling agents, flame retardants, color streakers, ultraviolet relective additives, infrared reflective additives, thermally conductive additives and pigments.

6. The composition of claim 2, wherein the polymeric composite comprises high density polyethylene, low density polyethylene and/or linear low density polyethylene.

7. The composition of claim 2, wherein the polymeric composite comprises polypropylene.

8. The composition of claim 2, wherein the first filler comprises wood flour and/or rice hulls.

9. The composition of claim 2, wherein the capstock comprises silane grafted polyethylene, linear low density polyethylene and calcium carbonate.

10. The composition of claim 2, wherein the capstock comprises silane grafted polyethylene, polyethylene and calcium carbonate; and the melt processable polymeric composite comprises wood flour and/or rice hulls and polyethylene and/or polypropylene .

11. The composition of claim 1, wherein the melt processable polymeric composite comprises between 15 and 80 wt. % of the first filler, which includes cellulosic material; and
the capstock includes 10 to 75 wt. % of the crosslinkable polymer and 10-60 wt. % of a second filler.

12. The composition of claim 11, wherein the melt polymeric composite comprises polyethylene and/or polypropylene; the first filler comprises wood flour; the crosslinkable polymer comprises alkoxysilane grafted polyethylene; and the second filler comprises calcium carbonate.

13. The composition of claim 1, wherein the melt processable polymeric composite comprises polyethylene and/or polypropylene and between 15 and 80 wt. % of the first filler, which includes wood flour; and the capstock includes polyethylene, 10 to 75 wt. % alkoxysilane grafted polyethylene and 10-60 wt. % calcium carbonate.

14. A method of producing the composite composition of claim 1 comprising coextruding the capstock with the melt processable polymeric composite.

15. A method according to claim 14, further comprising crosslinking the crosslinkable polymer.

16. A method according to claim 15, wherein crosslinking is accomplished by to exposure of the crosslinkable polymer to moisture.

17. A method comprising melt processing the composition of claim 1 to form an article.

18. An article comprising the composition according to claim 1.

19. An article according to claim 18, wherein the capstock encapsulates at least four sides of the substrate.

20. An article according to claim 18, wherein the article is a building component selected from the group consisting of decking, siding, roofing, and fencing.
